(19) United States
(12) Patent Application Publication
(10) Pub. No.: US 2026/0042921 A1
(43) Pub. Date: Feb. 12, 2026

(54) INK COMPOSITION AND WRITING INSTRUMENT

(71) Applicant: FUTURE CREATION & DEVELOPMENT CENTER LLC., Tokyo (JP)

(72) Inventors: Sayaka SHIMIZU, Tokyo (JP); Hitomi ITO, Tokyo (JP); Takashi YAMAUCHI, Tokyo (JP); Naoki KATO, Tokyo (JP)

(21) Appl. No.: 19/102,992

(22) PCT Filed: Aug. 24, 2023
(86) PCT No.: PCT/JP2023/030403

§ 371 Date: Feb. 11, 2025

(30) Foreign Application Priority Data
Aug. 25, 2022 (JP) 2022-133805
Apr. 25, 2023 (JP) 2023-071402

(51) Int. Cl. C09D 11/17; B43K 7/00; C09D 11/18

(52) U.S. Cl. CPC C09D 11/17; B43K 7/00; C09D 11/18

(57) ABSTRACT

An ink composition having erasability contains at least colored resin particles having an average particle size of 5 to 15 μm, a binder resin, and a solvent. A difference between a specific gravity of the colored resin particles and a specific gravity of components other than the colored resin particles is not less than 0.06 and not more than 0.7. The ink composition forms a film in which the binder resin enfolds the colored resin particles on a paper surface where the ink composition is ejected, without the colored resin particles settling on the paper surface.

### TECHNICAL FIELD

The present disclosure relates to an ink composition and a writing instrument.

### BACKGROUND ART

In the past, erasable ink compositions have been proposed for handwriting that can be erased by an eraser or the like. For example, Patent Document 1 discloses a water-based eraser-erasable ink composition that contains pigment particles (colored resin particles) with an average particle size of 2 to 30 μm as a colorant. In this ink composition, a polymer coagulant is added to develop a bridging structure between the pigment particles, preventing them from settling on the paper surface and separating.

### CITATION LIST

### Patent Literature

Patent Document 1: JP2004-143381A

### SUMMARY

### Problems to be Solved

However, the ink composition of Patent Document 1 tends to have a high viscosity because a relatively large amount of polymer coagulant that creates a bridging structure is added to suppress settling and separation of the colored resin particles. In addition, increasing the additive amount of the colored resin particles further increases the viscosity of the ink composition, resulting in poor ejection performance, making it difficult to obtain sufficient writing density. On the other hand, if the particle size of the pigment particles added is reduced as small as possible in order to obtain good ejection performance and sufficient writing density, the pigment particles may penetrate the paper surface, resulting in poor erasing performance.

The present invention was made in view of the above points, and an object thereof is to provide an ink composition having sufficient writing density, appropriate ejection performance, and good erasability, and a writing instrument with such an ink composition.

### Solution to the Problems

In order to solve the above-described problems, the inventors have conducted diligent research and found that, by satisfying a prescribed relationship between the colored resin particles and components other than the colored resin particles contained in the ink composition, it is possible to suppress the settling of ejected ink on the paper surface, and that the ink ejected on the paper surface forms a certain film and exhibits excellent erasability.

Specifically, the ink composition of the present invention is an erasable ink composition that contains at least colored resin particles with an average particle size of 5 to 15 μm, a binder resin, and a solvent, with a difference between the specific gravity of the colored resin particles and the specific gravity of components other than the colored resin particles of not less than 0.06 and not more than 0.7. The ink composition forms a film in which the binder resin enfolds the colored resin particles on a paper surface where the ink composition is ejected.

Further, the writing instrument of the present invention is filled with the above-described ink composition.

### Advantageous Effects

The present invention provides an ink composition having sufficient writing density, appropriate ejection performance, and good erasability, and a writing instrument with such an ink composition.

### BRIEF DESCRIPTION OF DRAWINGS

FIG. 1 is a schematic diagram showing the appearance of a ballpoint pen according to an embodiment, with (a) the cap attached and (b) the cap removed.

### DETAILED DESCRIPTION

### First Embodiment

An ink composition according to the first embodiment of the present invention will now be described. The ink composition according to this embodiment contains at least colored resin particles, a binder resin, and a solvent. The ink composition ejected on a paper surface does not settle on the paper surface (in other words, it does not penetrate the paper fibers), but a stroke of the ink composition forms a film on the paper surface. The ink composition according to this embodiment forms a certain film on the paper surface and exhibits excellent erasability by using a general eraser or the like. In other words, handwriting consisting of the film formed on the paper surface from the ink composition of this embodiment can be effectively erased by rubbing it off with an eraser while generating eraser shavings (film peeling shavings).

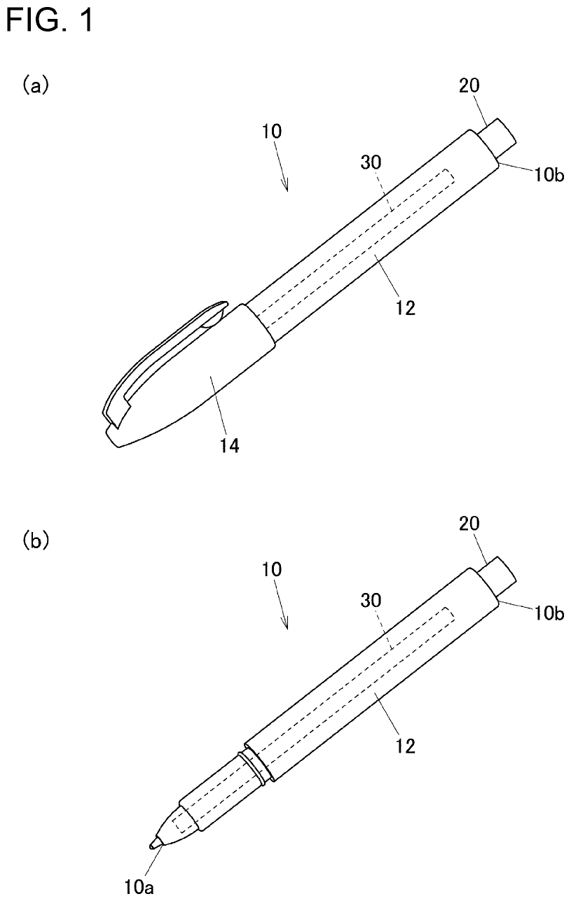

The ink composition according to this embodiment is used by being filled in a ballpoint pen, for example. Parts (a) and (b) of FIG. 1 schematically show the appearance of a capped ballpoint pen 10 containing the ink composition 30 according to an embodiment. As shown in parts (a) and (b) of FIG. 1, the ink composition 30 is filled in an ink tank of a refill (not shown) that is housed in a casing 12 of the ballpoint pen 10. The ink composition 30 is dispensed through a pen tip 10a of the ballpoint pen 10 housed in a cap 14.

In the casing 12 at a pen end 10b on the opposite side of the ballpoint pen 10 from the pen tip 10a, an eraser 20 is fixed to erase handwriting written in the ink composition 30 on the paper surface. The eraser 20 is fixed to the casing 12 so that it does not come off the casing 12 during rubbing. The eraser 20 may be attached to or covered by the casing 12 as well as fixed to the casing 12. The part of the ballpoint pen 10 to which the eraser 20 is attached is not limited to the casing 12 but can be any exterior part of the ballpoint pen 10 that is exposed to the outside. Examples of the exterior part herein include a cap, a tip part (nose cone), a barrel (casing), an end plug, a gripping part (grip), and an operating part (knocking part).

The eraser 20 is made of a predetermined elastomer and is viscoelastic with ink erasability for the ink composition 30. The eraser 20 is preferably made of a material such that the difference in SP (Solubility Parameter) value ((cal/cm3)½) from the binder resin contained in the ink composition 30, which will be described below, is not less than 0.1. The SP value here is calculated from the square root of the heat of evaporation required for 1 cm3 of liquid to evaporate. If the difference in SP value is not less than 0.1, the affinity between the eraser 20 and the binder resin blended in the ink composition 30 is low (less soluble), so that the binder resin will not spread on the paper surface when the ink composition writing on the paper surface is erased by rubbing.

Further, the eraser 20 is preferably made of a material such that the contact angle of a drop of the ink composition 30 to its surface is less than 60°. The contact angle here refers to the static contact angle, which can be measured, for example, by the θ/2 method. If the contact angle is less than 60°, when erasing handwriting, the eraser 20 and the film constituting the handwriting of the ink composition 30 are less slippery (it becomes harder to slide over the handwriting), and the film constituting the handwriting is more likely to stick to the eraser, making it easier to erase the handwriting.

Preferably, the material of the eraser 20 can be natural rubber, synthetic rubber, or synthetic resin, such as those commonly used for erasers. Illustrative examples of the synthetic rubber include styrene butadiene rubber, chloroprene rubber, butyl rubber, acrylonitrile butadiene rubber, acrylic rubber, urethane rubber, silicone rubber, and fluorinated rubber. Illustrative examples of the synthetic resin include polyvinyl chloride, polyethylene, polypropylene, and thermoplastic elastomers (polyurethane, styrene, olefin, polyethylene). By comparing the difference in SP value from the binder resin blended in the ink composition 30, an appropriate material can be selected from the above materials.

The ink composition 30 according to the present embodiment will now be described. The ink composition 30 contains colored resin particles having an average particle size of 5 to 15 μm with pigments such as carbon black encapsulated within. The average particle size of the colored resin particles is preferably about 6 μm. If the average particle size of the colored resin particles is smaller than 5 μm, the ink composition 30 ejected on the paper surface is more likely to settle on the paper surface and penetrate the paper fibers. On the other hand, if the average particle size of the colored resin particles is larger than 15 μm, the writing density decreases. If the average particle size of the colored resin particles is within the above range, the ink composition 30 is prevented from penetrating the paper fibers, and a practical handwriting density is achieved. The average particle size of the colored resin particles can be measured by dispersing the colored resin particles in water and using a laser rotation particle size distribution analyzer.

The ink composition 30 further contains a binder resin with adhesiveness to provide binding properties between the colored resin particles, and a solvent. The solvent includes all liquid components in the ink composition 30, such as a dispersant for dispersing the colored resin particles, a high boiling solvent for imparting so-called cap-off properties to the ink composition 30, liquid components in an aqueous thickener solution, and water.

In the ink composition 30, the difference between the specific gravity of the colored resin particles and the specific gravity of all components other than the colored resin particles, including the solvent, is not less than 0.06 and not more than 0.7. If the specific gravity difference is more than 0.7, the colored resin particles settle on the paper surface before a film is formed on the paper surface where the ink composition 30 is ejected, and the eraser may leave smudge when erasing handwriting of the ink composition 30. The composition with a specific gravity difference less than 0.06 contains many other components with high specific gravity, such as a dispersant, which results in an increase in the viscosity of the ink composition 30 and worsens the ejection performance. If the specific gravity difference is not less than 0.06 and not more than 0.7, the colored resin particles are prevented from settling on the paper surface before a film is formed on the paper surface, and the film is formed on the paper surface with the adhesive binder resin enfolding the colored resin particles. That is, the ink composition 30 forms a film in which the binder resin enfolds the colored resin particles on the paper surface where it is ejected. This improves the erasability of handwriting of the ink composition 30.

Furthermore, in the ink composition 30, if the average particle size of the colored resin particles is within the above range and the difference in specific gravity between the colored resin particles and components other than the colored resin particles is not less than 0.06 and not more than 0.7, a practical writing density is ensured while the ink composition 30 ejected on the paper surface is prevented from penetrating the paper fibers, and in addition, the binder resin enfolding the colored resin particles improves the erasability.

More preferably, the ink composition 30 has a difference in specific gravity between the colored resin particles and components other than the colored resin particles of not less than 0.25 and not more than 0.11. The smaller specific gravity difference further suppresses the settling of colored resin particles on the paper surface. This further improves the erasability of handwriting when erasing handwriting of the ink composition 30.

Further, it is preferable that the ink composition 30 forms a film having fixability on the paper surface where it is ejected. When the ink composition 30 forms a skinning film on the paper surface as described above, it is difficult for the film to peel off from the paper surface. In other words, since a film with fixability is formed on the paper surface, the film will not peel off from the paper surface unless it is intentionally erased. Thus, the formation of a film with fixability prevents part of the film from peeling off from the paper surface and sliding on the paper surface even when the surface of the film is rubbed with a finger or the like. Therefore, it is possible to achieve the ink composition 30 that does not smudge the paper.

The thickness of the film formed on the paper surface from the ejected ink composition 30 is preferably within the range of 1 to 100 μm. Since the minimum particle size of the colored resin particles in the ink composition 30 is about 1 μm, the thickness of the film may be at least 1 μm. On the other hand, if the thickness of the film is larger than 100 μm, when the ink composition 30 is ejected on the paper surface, it takes time for its solvent component to be absorbed by the paper surface and volatilized into the air, resulting in extremely slow drying and making it difficult to erase handwriting of the ink composition 30. If the thickness of the film is within the above range, it is easier to erase (rub off) handwriting consisting of the film when erasing it by rubbing with the eraser 20. If a material with a large particle size, such as glitter, is mixed in the ink composition 30, the thickness of the film may be increased by the thickness of this material.

The binder resin contained in the ink composition 30 is preferably acrylonitrile butadiene rubber (NBR). This is because when the binder resin is acrylonitrile butadiene rubber, the balance between the fixability of the ejected ink composition 30 on the paper surface and the erasability of handwriting of the ink composition 30 with an eraser is optimally maintained. In other words, the fixability prevents the film from smudging the paper surface when rubbed with a finger and allows the film to be fixed on the paper surface, unless it is intentionally erased. Examples of the binder resin other than acrylonitrile butadiene rubber include styrene butadiene rubber and urethane rubber.

The acrylonitrile butadiene rubber used as the binder resin in the ink composition 30 is preferably contained in an amount of 19 to 26 parts by weight of the total amount of the ink composition 30. If the blending amount of acrylonitrile butadiene rubber is less than 19 parts by weight, the binding property between the colored resin particles decreases, and the erasability of handwriting of the ink composition 30 deteriorates. On the other hand, if the blending amount of acrylonitrile butadiene rubber is greater than 26 parts by weight, the solid concentration in the ink composition 30 increases, so that the viscosity of the ink composition 30 increases, resulting in poor ejection performance. If the blending amount of acrylonitrile butadiene rubber is within the above range, the erasability of handwriting of the ink composition 30 is improved.

The colored resin particles are made by dispersing and blending various pigments, such as carbon black, in various resin materials, and the manufacturing methods include the melt kneading method, in which pigment components are blended with resin materials, melted and kneaded, and then ground into colored resin particles, and the suspension polymerization method, in which pigment components are dispersed and blended with polymerizable monomers, and subjected to suspension polymerization in an aqueous medium to produce colored resin particles. Alternatively, the colored resin particles may be obtained by coating pigments with resin materials. The resin material used for the colored resin particles in the ink composition 30 is preferably acrylic resin particles or urethane resin particles. The colored resin particles may have a hollow structure.

The pigments dispersed and blended in resin materials are not limited, but azo pigments, phthalocyanine pigments, anthraquinone pigments, quinacridone pigments, indigo pigments, dioxazine pigments, perylene pigments, perinone pigments, isoindolinone pigments, isoindoline pigments, metal complex pigments, quinophthalone pigments, diketopyrrolopyrrole pigments, titanium dioxide pigments, etc., can be used.

In addition to the colored resin particles and the binder resin, the ink composition 30 of this embodiment may contain a dispersant such as acrylics to disperse the colored resin particles, a high boiling solvent to impart so-called cap-off properties to the ink composition 30, a thickener to adjust the viscosity, and water. Various surfactants and water-soluble polymers with affinity for the colored resin particles can be used as the dispersant. The blending amount of water is adjusted according to the ejection performance (viscosity) of the ink composition 30. Regarding the ejection performance of the ink composition 30, it is preferable that the ink composition can continue to be ejected on the paper surface without fading, and it is more preferable that it can continue to be ejected on the paper surface without distinction between thick and thin.

It is preferable to keep the amount of high boiling solvent to the minimum necessary so that it does not interfere with other components, since adding too much reduces the handwriting drying property. Examples of the high boiling solvent include glycerin, ethylene glycol, diethylene glycol, and propylene glycol. The ink composition 30 of this embodiment is preferably blended with ethylene glycol as the high boiling solvent. Blending ethylene glycol improves the stability of the ink composition 30 in low-temperature environments.

Examples of the thickener include polysaccharides such as gum arabic, tragacanth gum, and xanthan gum, proteins such as casein and gelatin, cellulose derivatives such as methylcellulose and hydroxyethylcellulose, ethylene-propylene copolymer, polyvinyl alcohol, and bentonite. The ink composition 30 of this embodiment is preferably blended with xanthan gum as the thickener. Thickeners other than xanthan gum may be used as long as they impart shear thinning properties.

In addition, if necessary, the present invention may further contain additives to improve quick ink penetration into the writing surface and handwriting drying property, such as 3-methoxybutanol, 3-methyl-3-methoxybutanol, 3-methyl-1,3-butanediol, 1,3-butanediol, hexylene glycol (2-methylpentane-2,4-diol), wetting agents such as urea, ethyleneurea, and thiourea, preservatives such as phenoxyethanol, benzothiazolines, and omadines, as well as mold inhibitors, rust inhibitors, lubricants, antifoam agents, pH adjusters, brightening agents, and fragrances.

In the ink composition 30 of this embodiment, the additive amount of the colored resin particles is preferably 10 to 20% by weight, and the additive amount of the thickener is preferably not more than 0.4% by weight. If the additive amount of the colored resin particles is within the above range, sufficient writing density, appropriate ejection performance, and good erasability are achieved. Further, if the additive amount of the thickener is within the above range, appropriate ejection performance is achieved.

The ink composition 30 according to the present embodiment with the above configuration is an erasable ink composition that contains at least colored resin particles with an average particle size of 5 to 15 μm, a binder resin, and a solvent, with a difference between the specific gravity of the colored resin particles and the specific gravity of components other than the colored resin particles of not less than 0.06 and not more than 0.7. The ink composition forms a film in which the binder resin enfolds the colored resin particles on a paper surface where the ink composition is ejected.

That is, the ink composition 30 of this embodiment, which satisfies the above-described relationship between the colored resin particles and components other than the colored resin particles, suppresses the settling of colored resin particles on the paper surface and forms a film with fixability on the paper surface where it is ejected in the manner as described above. Therefore, handwriting consisting of the film formed on the paper surface can be easily erased by rubbing it off with an eraser while generating film peeling shavings. Thus, it is possible to achieve the ink composition 30 that is excellent in erasability while suppressing the settling of colored resin particles on the paper surface.

Furthermore, handwriting of the ink composition 30 of this embodiment, consisting of the film as described above, is superior in light and temperature resistance to that of conventional heat-discoloring inks, and the erased marks will not be restored due to changes in environmental temperature. In addition, since the settling of colored resin particles on the paper surface is suppressed, the handwriting density is higher than that of conventional heat-discoloring inks, and the writing comfort is also excellent.

Additionally, since handwriting of the ink composition 30 of this embodiment consists of the film as described above and the film has fixability on the paper surface, the paper is not smudged due to, for example, touching pencil marks. Additionally, since the settling of colored resin particles on the paper surface is suppressed, the handwriting density is higher than that of pencils, and the stroke width can be kept constant. As described above, the present embodiment provides a novel ink composition 30 that has sufficient writing density, appropriate ejection performance, and good erasability and overcomes the disadvantages of conventional heat-discoloring inks and pencils.

The ballpoint pen 10 according to the present embodiment is filled with the above-described ink composition 30. This provides a specific configuration for ejecting the ink composition 30 onto the paper surface to make handwriting.

### Second Embodiment

Next, an ink composition according to the second embodiment of the present invention will be described. The ink composition according to the second embodiment differs from that of the first embodiment in the particle size of the colored resin particles contained in the composition and in the difference between the specific gravity of the colored resin particles and the specific gravity of all components other than the colored resin particles. The other components in the ink composition, the structure of the colored resin particles, and the manufacturing method are the same as those for the ink composition 30 of the first embodiment, and therefore, their description will be omitted.

The ink composition 30 of this embodiment contains colored resin particles having an average particle size of less than 5 μm with pigments such as carbon black encapsulated within, and the difference between the specific gravity of the colored resin particles and the specific gravity of all components other than the colored resin particles, including the solvent, is not more than 0.05. If the average particle size is less than 5 μm but the specific gravity difference is more than 0.05, the colored resin particles settle before the film is formed on the paper surface, resulting in poor erasability. If the specific gravity difference is not more than 0.05 but the average particle size is not less than 5 μm (this composition contains many other components with high specific gravity, such as a dispersant), the large amount of components with high specific gravity increases the viscosity of the ink composition 30 and worsens the ejection performance.

From the above, if the average particle size is less than 5 μm and the difference between the specific gravity of the colored resin particles and the specific gravity of all components other than the colored resin particles, including the solvent, is not more than 0.05, the colored resin particles are prevented from settling on the paper surface before a film is formed on the paper surface, and the film is formed on the paper surface with the adhesive binder resin enfolding the colored resin particles, resulting in good erasability and further appropriate ejection performance. The resin material used for the colored resin particles in the ink composition of this embodiment is preferably polystyrene resin particles, polyethylene resin particles, or polypropylene resin particles.

By using, for example, polystyrene, polyethylene, or polypropylene materials to produce the colored resin particles, or by making the colored resin particles with a hollow structure, they do not settle in the solvent that is mainly acrylonitrile butadiene rubber. Furthermore, the acrylonitrile butadiene rubber emulsion forms an adhesive layer on the paper surface, on which the resin pigment is fixed, thereby maintaining erasability, and allows for a reduction in the particle size, thereby maintaining handwriting density.

The ink composition according to the present embodiment with the above configuration is an erasable ink composition that contains at least colored resin particles with an average particle size of less than 5 μm, a binder resin, and a solvent, with a difference between the specific gravity of the colored resin particles and the specific gravity of components other than the colored resin particles of not more than 0.05. The ink composition forms a film in which the binder resin enfolds the colored resin particles on a paper surface where the ink composition is ejected. Therefore, as with the ink composition 30 of the first embodiment, handwriting consisting of the film formed on the paper surface can be easily erased by rubbing it off with an eraser while generating film peeling shavings. Thus, even in this embodiment, it is possible to achieve an ink composition having sufficient writing density, appropriate ejection performance, and good erasability.

Embodiments of the present invention have been described above, but the present invention is not limited thereto. Various modifications can be made without departing from the spirit of the invention. For example, in the first embodiment, a ballpoint pen filled with the ink composition is described as an example, but there is no limitation on writing instruments that can be filled with the ink composition. For example, it may be a fountain pen or marker filled with the ink composition, or a writing brush with the ink composition.

### Example 1

### First Example

The present invention will be described in details with reference to Examples. In the first example, the optimal composition of the ink composition was studied. Specifically, 31 samples (25 example samples and 6 comparative example samples) of the ink composition were prepared by varying the type of the colored resin particles blended, the average particle size of the colored resin particles, the amount of the binder resin, and the difference in specific gravity between the colored resin particles and components other than the colored resin particles. Each of the 31 samples of the ink composition was evaluated for ejection performance, handwriting density (reworded as “applied portion density” in the experimental method), and handwriting erasability (reworded as “erased portion density” in the experimental method).

### (1) Composition of Each Ink Composition

Regarding the average particle size of the colored resin particles, 21 types of dispersions were used, in which colored resin particles with different average particle sizes were dispersed in an acrylic dispersant at a solid content of 45%. Regarding the type of the colored resin particles, 11 types of dispersions of acrylic colored resin particles (Dispersions A to F, H, I, L to N), 4 types of dispersions of urethane colored resin particles (Dispersions G, J, K, O), and 6 types of dispersions of polystyrene colored resin particles (Dispersions P to U) were used. The compositions of Dispersions A to G are shown in Table 1 below, Dispersions H to N in Table 2 below, and Dispersions O to U in Table 3 below. The composition of each dispersion is expressed in % by weight (the total is 100% by weight). The average particle size here is the D50 value calculated by the laser diffraction method on a volume basis.

TABLE 1

| | | | Specific gravity | | | | | | | |
|---|---|---|---|---|---|---|---|---|---|---|
| | | | of colored | Disper- | Disper- | Disper- | Disper- | Disper- | Disper- | Disper- |
| Composition | | | resin particle | sion A | sion B | sion C | sion D | sion E | sion F | sion G |
| Mean particle size | 0.235 | Acrylic | 1.8 | 60 | | | | | | |
| of colored resin | 3 | Acrylic | 1.12 | | 60 | | | | | |
| particle (μm) | 6 | Acrylic | 1.12 | | | 60 | | | | |
| | 11 | Acrylic | 1.12 | | | | 60 | | | |
| | 15 | Acrylic | 1.12 | | | | | 60 | | |
| | 18 | Acrylic | 1.12 | | | | | | 60 | |
| | 6 | Urethane | 1.26 | | | | | | | 60 |

| | | | | | | | |
|---|---|---|---|---|---|---|---|
| Acrylic dispersant | 25 | 10 | 10 | 10 | 10 | 10 | 10 |
| Water | 15 | 30 | 30 | 30 | 30 | 30 | 30 |
| Total | 100 | 100 | 100 | 100 | 100 | 100 | 100 |

TABLE 2

| | | | Specific gravity | | | | | | | |
|---|---|---|---|---|---|---|---|---|---|---|
| | | | of colored | Disper- | Disper- | Disper- | Disper- | Disper- | Disper- | Disper- |
| Composition | | | resin particle | sion H | sion I | sion J | sion K | sion L | sion M | sion N |
| Mean particle size | 6 | Acrylic | 1.12 | 30 | | | | 30 | | 60 |
| of colored resin | 15 | Acrylic | 1.12 | | 30 | | | | 30 | |
| particle (μm) | 6 | Urethane | 1.17 | | | 60 | | | | |
| | 15 | Urethane | 1.17 | | | | 60 | | | |

| | | | | | | | |
|---|---|---|---|---|---|---|---|
| Acrylic dispersant | 50 | 50 | 6 | 6 | 55 | 55 | 8 |
| Water | 20 | 20 | 34 | 34 | 15 | 15 | 32 |
| Total | 100 | 100 | 100 | 100 | 100 | 100 | 100 |

TABLE 3

| | | | Specific gravity | | | | | | | |
|---|---|---|---|---|---|---|---|---|---|---|
| | | | of colored | Disper- | Disper- | Disper- | Disper- | Disper- | Disper- | Disper- |
| Composition | | | resin particle | sion O | sion P | sion Q | sion R | sion S | sion T | sion U |
| Polystyrene | 6 | Urethane | 1.26 | 60 | | | | | | |
| Mean particle size | 0.02 | Polystyrene | 1.045 | | 60 | | | | | |
| of colored resin | 0.1 | Polystyrene | 1.045 | | | 60 | | | | |
| particle (μm) | 0.3 | Polystyrene | 1.045 | | | | 60 | | | |
| | 1 | Polystyrene | 1.045 | | | | | 60 | | |
| | 3 | Polystyrene | 1.045 | | | | | | 60 | |
| | 6 | Polystyrene | 1.045 | | | | | | | 60 |

| | | | | | | | |
|---|---|---|---|---|---|---|---|
| Acrylic dispersant | 0.3 | 25 | 25 | 25 | 25 | 25 | 25 |
| Water | 39.7 | 15 | 15 | 15 | 15 | 15 | 15 |
| Total | 100 | 100 | 100 | 100 | 100 | 100 | 100 |

Regarding the blending amount of the binder resin, acrylonitrile butadiene rubber (NBR) was used as the binder resin blended in each ink composition. Specifically, NBR emulsion with a solid content of 48.5% was used. For each ink composition, the amount of acrylonitrile butadiene rubber (hereinafter referred to as “NBR amount”) was varied within the range of 19 to 27% by weight. Regarding the difference in specific gravity between the colored resin particles and components other than the colored resin particles, ink compositions with specific gravity differences of 0.05, 0.07, 0.1, 0.11, 0.13, 0.25, 0.26, 0.7, and 0.79 were prepared.

For each ink composition, in addition to the colored resin particles (Dispersions A to G) and the binder resin (acrylonitrile butadiene rubber), ethylene glycol as a high boiling solvent, 3% aqueous xanthan gum solution as a thickener, and water were blended. As the samples where the difference in specific gravity between the colored resin particles and components other than the colored resin particles is not less than 0.06, Table 4 shows the compositions of Examples 1 to 10, Table 5 shows the compositions of Examples 11 to 20, and Table 6 shows the compositions of Comparative Examples 1 to 6. As the samples where the difference in specific gravity between the colored resin particles and components other than the colored resin particles is not more than 0.05, Table 6 shows the compositions of Comparative Examples 4 and 5, and Table 7 shows the compositions of Examples 21 to 25 and Comparative Example 6. The composition shown in Tables 4 to 7 is expressed in % by weight (the total is 100% by weight).

TABLE 4

| | | Example | | | | | | | | | |
|---|---|---|---|---|---|---|---|---|---|---|---|
| | | 1 | 2 | 3 | 4 | 5 | 6 | 7 | 8 | 9 | 10 |
| Colored | Dispersion C | 29 | 29 | 29 | | | 29 | 29 | | | |
| resin | Dispersion D | | | | 29 | | | | | | |
| particle | Dispersion E | | | | | 29 | | | | | |
| | Dispersion G | | | | | | | | 29 | 29 | |
| | Dispersion H | | | | | | | | | | 39 |

| | | | | | | | | | | |
|---|---|---|---|---|---|---|---|---|---|---|
| Binder resin | 40 | 49 | 54 | 49 | 49 | 36 | 55 | 49 | 49 | 40 |
| High boiling solvent | 10 | 10 | 10 | 10 | 10 | 10 | 10 | 10 | 3 | 15 |
| Thickener | 12 | 10 | 6 | 10 | 10 | 13 | 6 | 10 | 10 | 5 |
| Water | 9 | 2 | 1 | 2 | 2 | 12 | 0 | 2 | 9 | 1 |
| NBR solid | 19 | 24 | 26 | 24 | 24 | 17 | 27 | 24 | 24 | 19 |
| Specific gravity difference | 0.11 | 0.11 | 0.11 | 0.11 | 0.11 | 0.11 | 0.11 | 0.25 | 0.26 | 0.07 |

TABLE 5

| | | Example | | | | | | | | | |
|---|---|---|---|---|---|---|---|---|---|---|---|
| | | 11 | 12 | 13 | 14 | 15 | 16 | 17 | 18 | 19 | 20 |
| Colored | Dispersion C | | | | 20 | 32 | 29 | | 35 | | |
| resin | Dispersion I | 45 | | | | | | | | | |
| particle | Dispersion J | | 29 | | | | | | | | |
| | Dispersion K | | | 29 | | | | | | | |
| | Dispersion N | | | | | | | 15 | | 29 | 29 |

| | | | | | | | | | | |
|---|---|---|---|---|---|---|---|---|---|---|
| Binder resin | 40 | 43 | 43 | 49 | 49 | 49 | 2 | 47 | 52 | 45 |
| High boiling solvent | 11 | 3 | 3 | 10 | 10 | 10 | 15 | 10 | 10 | 9 |
| Thickener | 4 | 4 | 8 | 10 | 8 | 3 | 12 | 7 | 3 | 15 |
| Water | 0 | 21 | 17 | 11 | 1 | 9 | 56 | 1 | 6.5 | 2 |
| NBR solid | 19 | 21 | 21 | 24 | 24 | 24 | 1 | 23 | 25 | 22 |
| Specific gravity difference | 0.07 | 0.7 | 0.7 | 0.11 | 0.11 | 0.11 | 0.1 | 0.13 | 0.13 | 0.13 |

TABLE 6

| | | Comparative Example | | | | |
|---|---|---|---|---|---|---|
| | | 1 | 2 | 3 | 4 | 5 |
| Colored | Dispersion A | | | 5 | | |
| resin | Dispersion B | 29 | | | | |
| particle | Dispersion F | | 29 | | | |
| | Dispersion L | | | | 39 | |
| | Dispersion M | | | | | 44 |
| | Dispersion O | | | | | |

| | | | | | |
|---|---|---|---|---|---|
| Binder resin | 49 | 49 | 50 | 40 | 40 |
| High boiling solvent | 10 | 10 | 10 | 16 | 12 |
| Thickener | 10 | 10 | 33 | 4 | 4 |
| Water | 2 | 2 | 2 | 1 | 0 |
| NBR solid | 24 | 24 | 24 | 19 | 19 |
| Specific gravity difference | 0.11 | 0.11 | 0.79 | 0.05 | 0.05 |

TABLE 7

| | | | | | | | Comp. |
|---|---|---|---|---|---|---|---|
| | | Example | | | | | Exam- |
| | | 21 | 22 | 23 | 24 | 25 | ple 6 |
| Colored | Dispersion P | 5 | | | | | |
| resin | Dispersion Q | | 5 | | | | |
| particle | Dispersion R | | | 5 | | | |
| | Dispersion S | | | | 5 | | |
| | Dispersion T | | | | | 5 | |
| | Dispersion U | | | | | | 5 |

| | | | | | | |
|---|---|---|---|---|---|---|
| Binder resin | 50 | 50 | 50 | 50 | 50 | 50 |
| High boiling solvent | 10 | 10 | 10 | 10 | 10 | 10 |
| Thickener | 10 | 10 | 33 | 10 | 10 | 10 |
| Water | 25 | 25 | 25 | 25 | 25 | 25 |
| NBR solid | 24 | 24 | 24 | 24 | 24 | 24 |
| Specific gravity difference | 0.05 | 0.05 | 0.05 | 0.05 | 0.05 | 0.05 |

For the comparative study of the average particle size of the colored resin particles blended, samples of the ink composition of Examples 1 to 20 were prepared from Dispersions C, D, E, G, H, I, J, K, and N with colored resin particles having average particle sizes of 6 μm, 11 μm, and 15 μm, respectively (see Tables 4 and 5), and samples of the ink composition of Examples 21 to 25 were prepared from Dispersions P, Q, R, S, and T with colored resin particles having average particle sizes of 0.02 μm, 0.1 μm, 0.3 μm, 1 μm, and 3 μm, respectively (see Table 7). On the other hand, samples of the ink compositions of Comparative Examples 1 to 5 were prepared from Dispersions A, B, F, L, M, and O with colored resin particles having average particle sizes of 0.235 μm, 3 μm, 6 μm, 15 μm, and 18 μm (see Table 6), and a sample of the ink composition of Comparative Example 6 was prepared from Dispersion U with colored resin particles having an average particle size of 6 μm (see Table 7).

For the comparative study of the blending amount of the binder resin, the sample of the ink composition of Example 17 was prepared with 1% by weight of NBR, the sample of the ink composition of Example 6 was prepared with 17% by weight of NBR, the samples of the ink composition of Examples 1, 10, and 11 were prepared with 19% by weight of NBR, the samples of the ink composition of Examples 12 and 13 were prepared with 21% by weight of NBR, the sample of the ink composition of Example 20 was prepared with 22% by weight of NBR, the sample of the ink composition of Example 18 was prepared with 23% by weight of NBR, the samples of the ink composition of Examples 2, 4, 5, 8, 9, 14 to 16, and 21 to 25 were prepared with 24% by weight of NBR, the sample of the ink composition of Example 19 was prepared with 25% by weight of NBR, the sample of the ink composition of Example 3 was prepared with 26% by weight of NBR, and the sample of the ink composition of Example 7 was prepared with 27% by weight of NBR (see Tables 6 and 7).

On the other hand, the samples of the ink composition of Comparative Examples 4 and 5 were prepared with 19% by weight of NBR, and the samples of the ink composition of Comparative Examples 1 to 3 and 6 were prepared with 24% by weight of NBR (see Tables 6 and 7).

The difference in specific gravity between the colored resin particles and components other than the colored resin particles was compared and studied by adjusting the specific gravity difference to be 0.11 for the samples of the ink composition of Examples 1 to 7 and 14 to 16, 0.25 for the sample of the ink composition of Example 8, 0.26 for the sample of the ink composition of Example 9, 0.07 for the samples of the ink composition of Examples 10 and 11, 0.7 for the samples of the ink composition of Examples 12 and 13, 0.1 for the sample of the ink composition of Example 17, 0.13 for the samples of the ink composition of Examples 18 to 20, and 0.05 for the samples of the ink composition of Examples 21 to 25 (see Tables 4, 5, and 7).

On the other hand, the ink compositions were prepared by adjusting the specific gravity difference to be 0.11 for the samples of the ink compositions of Comparative Examples 1 and 2, 0.79 for the sample of the ink composition of Comparative Example 3, and 0.05 for the samples of the ink compositions of Comparative Examples 4, 5 and 6 (see Tables 6 and 7).

### (2) Evaluation of Each Ink Composition

To evaluate the ejection performance of each ink composition, each ink composition filled in a ballpoint pen was ejected onto paper (content paper in accordance with JIS-S-5504) to make handwriting. A grade of “excellent” (double circle) was given to those that continued to be ejected on the paper without distinction between thick and thin, “good” (circle) to those that became slightly faint while being ejected but the handwriting was not affected at all, “fair” (triangle) to those that became slightly faint while being ejected but the handwriting could be written, and “poor” (cross) to those that became faint and the handwriting could not be written on the paper.

To evaluate the applied portion density of each ink composition, each ink composition was ejected onto paper described above with a bar coater (No. 7, manufactured by Imoto machinery. Co., Ltd.) to form a film of a certain thickness on the paper surface. The optical density of the film formed on the paper surface was then measured using a fluorescence spectrodensitometer (FD-5, manufactured by Konica Minolta, Inc.). The measurement results were rated as follows: “excellent” (double circle), score of 1.0 or more: “good” (circle), less than 1.0 and 0.9 or more: “fair” (triangle), less than 0.9 and 0.8 or more: “poor” (cross), less than 0.8.

To evaluate the erased portion density of each ink composition, each film used for evaluating the applied portion density was erased by rubbing it off with a general eraser (PVC: 30-40%, plasticizer: 40-50%, others: 10-30%) under a load of 1 kg, and the optical density was measured using the above-described fluorescence spectrodensitometer. The measurement results were rated as follows: “excellent” (double circle), score of 0.012 or less; “good” (circle), more than 0.12 and 0.18 or less, “fair” (triangle), more than 0.18 and 0.02 or less: “poor” (cross), more than 0.02.

### (3) Evaluation Result

The evaluation results of the ejection performance, applied portion density, and erased portion density for each ink composition are shown in Table 8 below for Examples 1 to 20 and Comparative Examples 1 to 5, and in Table 9 below for Examples 21 to 25 and Comparative Example 6.

TABLE 8

| | | Applied | Erased |
|---|---|---|---|
| | Ejection | portion | portion |
| | performance | density | density |
| Example 1 | ⊚ | ⊚ | ⊚ |
| Example 2 | ⊚ | ⊚ | ⊚ |
| Example 3 | ◯ | ⊚ | ⊚ |
| Example 4 | ⊚ | ◯ | ⊚ |
| Example 5 | ⊚ | ◯ | ⊚ |
| Example 6 | ◯ | ⊚ | ◯ |
| Example 7 | ◯ | ◯ | ⊚ |
| Example 8 | ⊚ | ⊚ | ◯ |
| Example 9 | ⊚ | ⊚ | Δ |
| Example 10 | ⊚ | ⊚ | ⊚ |
| Example 11 | ⊚ | ◯ | ⊚ |
| Example 12 | ⊚ | ⊚ | Δ |
| Example 13 | ⊚ | ◯ | Δ |
| Example 14 | ⊚ | ◯ | ⊚ |
| Example 15 | ◯ | ⊚ | ◯ |
| Example 16 | ⊚ | ⊚ | ◯ |
| Example 17 | ◯ | Δ | ◯ |
| Example 18 | Δ | ◯ | Δ |
| Example 19 | ⊚ | ◯ | ◯ |
| Example 20 | Δ | ◯ | ◯ |
| Comparative Example 1 | ◯ | ⊚ | X |
| Comparative Example 2 | X | X | ⊚ |
| Comparative Example 3 | ◯ | ⊚ | X |
| Comparative Example 4 | X | ◯ | ⊚ |
| Comparative Example 5 | X | ◯ | ⊚ |

⊚: Excellent, ◯: Good, Δ: Fair, X: Poor

TABLE 9

| | | Applied | Erased |
|---|---|---|---|
| | Ejection | portion | portion |
| | performance | density | density |
| Example 21 | ⊚ | ⊚ | Δ |
| Example 22 | ⊚ | ⊚ | Δ |
| Example 23 | ⊚ | ⊚ | Δ |
| Example 24 | ⊚ | ◯ | ◯ |
| Example 25 | ⊚ | ◯ | ⊚ |
| Comparative Example 6 | ⊚ | X | ⊚ |

⊚: Excellent, ◯: Good, Δ: Fair, X: Poor

First, the evaluation results of Examples 1 to 20 and Comparative Examples 1 to 6 are discussed. As shown in Table 8, regarding the comparative study of ejection performance, it was confirmed that the ink compositions of all of Examples 1 to 20 and Comparative Examples 1 and 3 were rated “excellent”, “good” or “fair”. Regarding the comparative study of applied portion density, it was confirmed that the ink compositions of all of Examples 1 to 20 and Comparative Examples 1 to 6, excluding Comparative Example 2, were rated “excellent”, “good” or “fair”. Regarding the comparative study of erased portion density, it was confirmed that the ink compositions of all of Examples 1 to 20 and Comparative Examples 1 to 5, excluding Comparative Examples 1 and 3, were rated “excellent”, “good” or “fair”.

If all evaluation items, including ejection performance, applied portion density, and erased portion density, are rated at least “fair”, it is possible to ensure practical writing density while preventing the ink from penetrating the paper fibers when the ink composition 30 is ejected onto the paper, and furthermore, it is possible to improve the erasability with the binder resin enfolding the colored resin particles.

In the evaluation study of Examples 1 to 20 and Comparative Examples 1 to 6, at least one of the evaluation items was rated “poor” in Comparative Examples 1 to 6. On the other hand, of Examples 1 to 20, Examples 1 to 8, 10, 11, 14 to 16, and 19 had good evaluation results with all evaluation items rated at least “good”. In these examples, the difference in specific gravity between the colored resin particles and components other than the colored resin particles is not more than 0.25. The ink compositions of Examples 1 to 5, 8, 10, 11, 14, and 16, which had better evaluation results, contain dispersions of acrylic colored resin particles or urethane colored resin particles having an average particle size in the range of 5 to 15 μm, and NBR blended in the range of 19 to 26% by weight, with a difference in specific gravity between the colored resin particles and components other than the colored resin particles of not more than 0.25.

Of Examples 1 to 20, the ink compositions of Examples 1, 2 and 10, which had the highest evaluation results with all evaluation items, including ejection performance, applied portion density, and erased portion density, rated “excellent”, contain colored resin particles having an average particle size of 6 μm, and NBR blended in the range of 19 to 24% by weight, with a difference in specific gravity between the colored resin particles and the solvent of not less than 0.06 and not more than 0.11, indicating that this is the optimal composition for the ink composition that contains colored resin particles having an average particle size of 5 to 15 μm.

Next, the evaluation results of Examples 21 to 25 and Comparative Example 6 are discussed. As shown in Table 9, regarding the comparative study of ejection performance, it was confirmed that the ink compositions of all of Examples 21 to 25 and Comparative Example 7 were rated “excellent”. Regarding the comparative study of applied portion density, it was confirmed that only Comparative Example 7 was rated “poor”, and Examples 21 to 25 were rated “excellent” or “good”. Regarding the comparative study of erased portion density, it was confirmed that the ink compositions of all of Examples 21 to 25 and Comparative Example 7 were rated “excellent”, “good” or “fair”.

In the evaluation study of Examples 21 to 25 and Comparative Example 7, Examples 24 and 25 had good evaluation results with all evaluation items rated at least “good”. In these examples, the difference in specific gravity between the colored resin particles and components other than the colored resin particles is 0.05. The ink compositions of Example 25, which had better evaluation results, contain dispersions of polystyrene colored resin particles having an average particle size of 3 μm, and 24% by weight of NBR, with a difference in specific gravity between the colored resin particles and components other than the colored resin particles of 0.05, indicating that this is the optimal composition for the ink composition that contains colored resin particles having an average particle size of less than 5 μm.

### Second Example

In the second example, the thickness of the film formed of the ink composition ejected on the paper surface was measured. The ink composition used for the measurement was the ink composition of Example 2 shown in Table 2. The ink composition was dispensed through a ballpoint pen filled with the ink, and the ink composition was ejected onto paper in accordance with JIS-S-5504.

Specifically, the film thickness was measured as follows. First, five straight lines were written by ejecting the ink composition on the paper surface. Then, the area near the center of each line was erased by a general eraser used in the first example. Then, for each line, the thickness of the area where the ink composition was not erased and the area where the ink composition was erased were measured. The difference between the area where the ink composition was not erased and the area where the ink composition was erased was then calculated, and the calculated difference was used as the film thickness. This eliminates the effect of indentation of the paper due to writing pressure.

The film thickness was measured using a step meter (VR-3000 manufactured by KEYENCE Corporation) at two points per line (the film thickness was measured at the point where the ink composition was not erased and at the point where the ink composition was erased), for a total of 10 areas (Area 1 to Area 10). The measurement results are shown in Table 10 below.

TABLE 10

| | Film thickness (μm) |
|---|---|
| Area 1 | 56 |
| Area 2 | 16 |
| Area 3 | 48 |
| Area 4 | 44 |
| Area 5 | 29 |
| Area 6 | 18 |
| Area 7 | 26 |
| Area 8 | 32 |
| Area 9 | 25 |
| Area 10 | 17 |
| Maximum | 56 |
| Minimum | 16 |
| Average | 31 |

As shown in Table 10, it was confirmed that the thickness of the film formed of the ink composition ejected onto the paper surface was within the range of 16 to 56 μm. Considering that the minimum particle size of the colored resin particles blended in the ink composition is about 1 μm, and that particles other than the colored resin particles such as glitter (average particle size of 100 μm) may be mixed in, the film formed of the ink composition is estimated to have a thickness in the range of 1 to 100 μm.

### INDUSTRIAL APPLICABILITY

The present invention provides an ink composition having sufficient writing density, appropriate ejection performance, and good erasability, and a writing instrument with such an ink composition.

### REFERENCE SIGNS LIST

10 Ballpoint pen
10a Pen tip
10b Pen end
12 Casing
14 Cap
20 Eraser
30 Ink composition

1. An ink composition having erasability, comprising at least colored resin particles having an average particle size of 5 to 15 μm, a binder resin, and a solvent,
wherein a difference between a specific gravity of the colored resin particles and a specific gravity of components other than the colored resin particles is not less than 0.06 and not more than 0.7, and
wherein the ink composition forms a film in which the binder resin enfolds the colored resin particles on a paper surface where the ink composition is ejected.

2. The ink composition according to claim 1,
wherein the difference between the specific gravity of the colored resin particles and the specific gravity of the components other than the colored resin particles is not more than 0.25.

3. The ink composition according to claim 2,
wherein a film having fixability is formed on a paper surface where the ink composition is ejected.

4. The ink composition according to claim 3,
wherein a thickness of the film is within a range of 1 to 100 μm.

5. The ink composition according to claim 1,
wherein the binder resin is acrylonitrile butadiene rubber.

6. The ink composition according to claim 4, comprising 19 to 26 parts by weight of acrylonitrile butadiene rubber.

7. The ink composition according to claim 1, wherein the colored resin particles are acrylic resin particles or urethane resin particles.

8. The ink composition according to claim 1, wherein an additive amount of the colored resin particles is 10 to 20% by weight, and the ink composition comprises a thickener in an additive amount of not more than 0.4% by weight.

9. A writing instrument, filled with the ink composition according to claim 1.

10. An ink composition having erasability, comprising at least colored resin particles having an average particle size of less than 5 μm, a binder resin, and a solvent,
wherein a difference between a specific gravity of the colored resin particles and a specific gravity of components other than the colored resin particles is not more than 0.05,
wherein the ink composition forms a film in which the binder resin enfolds the colored resin particles on a paper surface where the ink composition is ejected, and
wherein the colored resin particles includes polystyrene resin particles, polyethylene resin particles, or polypropylene resin particles.

11. The ink composition according to claim 10,
wherein a film having fixability is formed on a paper surface where the ink composition is ejected.

12. The ink composition according to claim 11,
wherein a thickness of the film is within a range of 1 to 100 μm.

13. The ink composition according to claim 10,
wherein the binder resin is acrylonitrile butadiene rubber.

14. The ink composition according to claim 12, comprising 19 to 26 parts by weight of acrylonitrile butadiene rubber.

15. (canceled)

16. The ink composition according to claim 10, wherein an additive amount of the colored resin particles is 10 to 20% by weight, and the ink composition comprises a thickener in an additive amount of not more than 0.4% by weight.
